(19) United States
(12) Patent Application Publication
(10) Pub. No.: US 2016/0187156 A1
(43) Pub. Date: Jun. 30, 2016

(54) Method and Device for Setting the Dynamic Range of a Rotation Rate Sensor

(71) Applicant: ROBERT BOSCH GMBH, Stuttgart (DE)

(72) Inventors: Jens Strobel, Freiberg Am Neckar (DE); Thomas Northemann, Gerlingen (DE)

(21) Appl. No.: 14/910,409

(22) PCT Filed: Jul. 9, 2014
(86) PCT No.: PCT/EP2014/064693

§ 371 Date: Feb. 5, 2016

(30) Foreign Application Priority Data
Aug. 7, 2013 (DE) 10 2013 215 587.5

(51) Int. Cl. G01C 25/00; G01C 19/5776

(52) U.S. Cl. CPC G01C 25/005; G01C 19/5776

(57) ABSTRACT

A method for setting the dynamic range of a rotation rate sensor includes exciting a mass of the rotation rate sensor mounted such that the mass is configured to vibrate linearly using a drive signal. The drive signal is provided at a resonant frequency of the mass. The method further includes influencing the vibration by using an amplification signal. The amplification signal is provided at a multiple of the resonant frequency in order to set a dynamic range.

### PRIOR ART

The present invention relates to a method for setting the dynamic range of a rotation rate sensor, to a corresponding device and to a rotation rate sensor.

A rotational speed of a body can be measured via a rotation rate sensor which is rigidly connected to the body and co-rotates with said body.

DE 10 2008 043 796 A1 describes a rotation rate sensor.

### DISCLOSURE OF THE INVENTION

Against this background, the present invention presents a method for setting the dynamic range of a rotation rate sensor, furthermore a device which uses said method and finally a corresponding computer program product, according to the main claims. Advantageous refinements emerge from the respective subclaims and the following description.

In a rotation rate sensor a mass mounted such that it can vibrate can be excited to vibrate linearly. If the rotation rate sensor is then rotated transversely with respect to a direction of the vibration, the Coriolis force acts on the vibrating mass. As a result of the Coriolis force, the mass is deflected transversely with respect to the axis of the rotation and transversely with respect to the direction of the vibration. This deflection can be measured. A rotational speed of the rotation can be determined from the deflection.

In order to be able to cover a wide sensitivity range with a single rotation rate sensor, either very precise measurement of the deflection over a wide measurement range is required or a speed of movement of the mass can be matched to a desired sensitivity.

Low rotational speeds can be measured with a high speed. High rotational speeds can be measured with a low speed.

The speed of the mass depends directly on a vibration amplitude of the mass.

By exciting the mass into a basic vibration by using a first signal and influencing the basic vibration by means of a second signal, the vibration amplitude of the mass of the rotation rate sensor can be adapted.

A method for setting the dynamic range of a rotation rate sensor is presented, wherein the method has the following steps:

exciting a mass of the rotation rate sensor mounted such that it can vibrate to vibrate linearly by using a drive signal, wherein the drive signal is provided at a resonant frequency of the mass; and
influencing the vibration by using an amplification signal, wherein the amplification signal is provided in particular at a multiple of the resonant frequency in order to set the dynamic range.

Furthermore, a device for setting the dynamic range of a rotation rate sensor is presented, wherein the device has the following features:

a means for exciting a mass of the rotation rate sensor mounted such that it can vibrate by using a drive signal, wherein the excitation means is designed to provide the drive signal at a resonant frequency of the mass; and
a means for influencing the mass by using an amplification signal, wherein the influencing means is designed to provide the amplification signal at a multiple of the resonant frequency in order to set the dynamic range.

In addition, by means of this design variant of the invention in the form of a device, the object on which the invention is based can be achieved quickly and efficiently.

In the present case, a device can be understood to mean an electric appliance which processes sensor signals and, depending on the latter, outputs control and/or data signals. The device can have an interface which can be implemented by hardware and/or software. In the case of a hardware implementation, the interfaces can, for example, be part of a so-called system ASIC which includes an extremely wide range of functions of the device. However, it is also possible for the interfaces to be individual integrated circuits or at least partly to comprise discrete components. In the case of a software implementation, the interfaces can be software modules which, for example, are present on a microcontroller beside other software modules.

Furthermore, a rotation rate sensor having the following features is presented:

at least one mass mounted such that it can vibrate, wherein the mass can be excited by electrostatic forces;
at least one electrode for exciting the mass;
a means for exciting the mass by using a drive signal, wherein the excitation means is designed to provide the drive signal on the electrode in particular at a resonant frequency of the mass; and
a means for influencing the mass by using an amplification signal, wherein the influencing means is designed to provide the amplification signal at a multiple of the resonant frequency in order to set a dynamic range of the rotation rate sensor.

Dynamic range can be understood to mean a spectrum of measurable rotation rates. A mass mounted such that it can vibrate can be a mass element which is connected to a frame by at least one spring. The mass can also be mounted in a damped manner in order to permit controlled amplification of the vibration. The drive signal can be an electric voltage with variable voltage level. The drive signal can be provided approximately sinusoidally. A resonant frequency of the mass can be determined by a spring stiffness, a level of damping and a mass of the mass. An amplification signal can be an electric voltage with variable voltage level. The amplification signal can be provided approximately sinusoidally.

The amplification signal can be provided with a phase offset in relation to the drive signal. A phase offset can be a shift of a zero crossing of the amplification signal as compared with a zero crossing of the drive signal. The phase offset can be incorporated directly into a transfer function of the two frequencies and effect amplification or attenuation of the basic vibration.

A first dynamic stage of the dynamic range can be set by using a first phase offset. Following chronologically thereon, a second dynamic stage of the dynamic range can be set by using a second phase offset. The first phase offset is different from the second phase offset. It is possible to provide discrete stages of the phase offset. As a result, a large dynamic range can be implemented with little outlay on circuitry.

The amplification signal can be provided with a variable amplitude in order to influence the dynamic range. In the case of a high amplitude, the basic vibration can be increased. In the case of a low amplitude, the basic vibration can be reduced. The amplification signal can be adapted simply.

The amplification signal can be provided at twice the resonant frequency. By means of twice the resonant frequency, the basic vibration can be influenced simultaneously in four phases.

The drive signal can be provided in the high-voltage range. The amplification signal can be provided in the low-voltage range. The high-voltage range can be arranged between 10 and 30 V, in particular between 15 and 25 V, in particular in the range around 20 V. The low-voltage range can be arranged between 0 and 10 V, in particular between 0 and 6 V, in particular between 0 and 3 V.

The drive signal can be provided as an oscillating AC signal. The drive signal can be provided as an AC signal oscillating sinusoidally about a voltage value. The drive signal can move the mass alternately in one direction and in a direction opposite to the direction. Therefore, the mass can vibrate simply at resonance.

The amplification signal can be provided as a DC signal fluctuating sinusoidally about a voltage value. The amplification signal can provide a directed spring force. The spring force can be directed in a direction of the basic vibration in order to influence the basic vibration.

The drive signal and the amplification signal can be provided on a common electrode or on opposite electrodes. Installation space in the rotation rate sensor can be saved by using a common electrode. The electrodes can in particular be parallel electrodes.

The drive signal can be provided on at least one drive electrode. The amplification signal can be provided on at least one parallel electrode. By means of separate electrodes, a simplified circuit for driving the electrodes can be used.

Also advantageous is a computer program product with program code, which can be stored on a machine-readable carrier such as a semiconductor memory, a hard disk memory or an optical memory, and which is used to carry out the method according to one of the embodiments described above when the program product is executed on a computer or a device.

The invention will be explained in more detail below by way of example by using the appended drawings, in which:

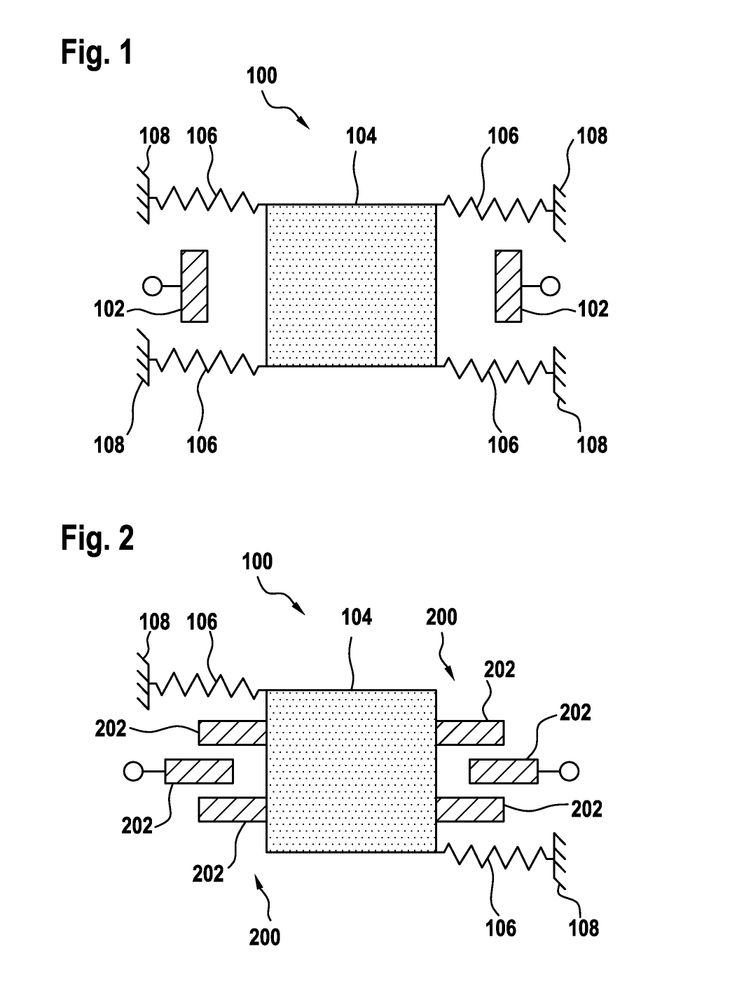

FIG. 1 shows an illustration of a rotation rate sensor having parallel electrodes according to an exemplary embodiment of the present invention;

FIG. 2 shows an illustration of a rotation rate sensor having comb electrodes according to an exemplary embodiment of the present invention;

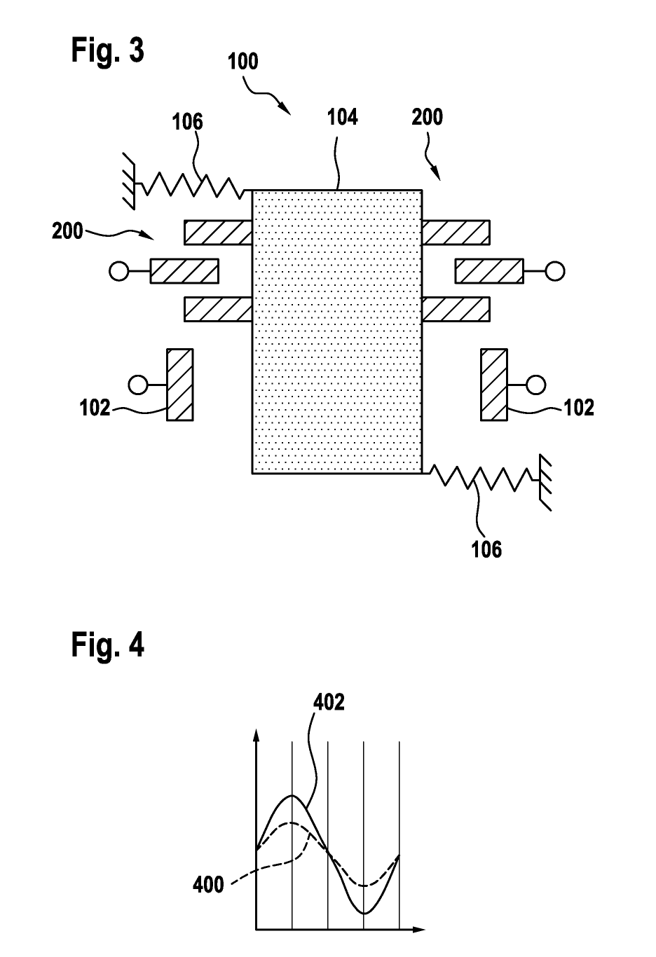

FIG. 3 shows an illustration of a rotation rate sensor having comb electrodes and parallel electrodes according to an exemplary embodiment of the present invention;

FIG. 4 shows an illustration of influencing a vibration of a mass of a rotation rate sensor by means of an increase in amplitude;

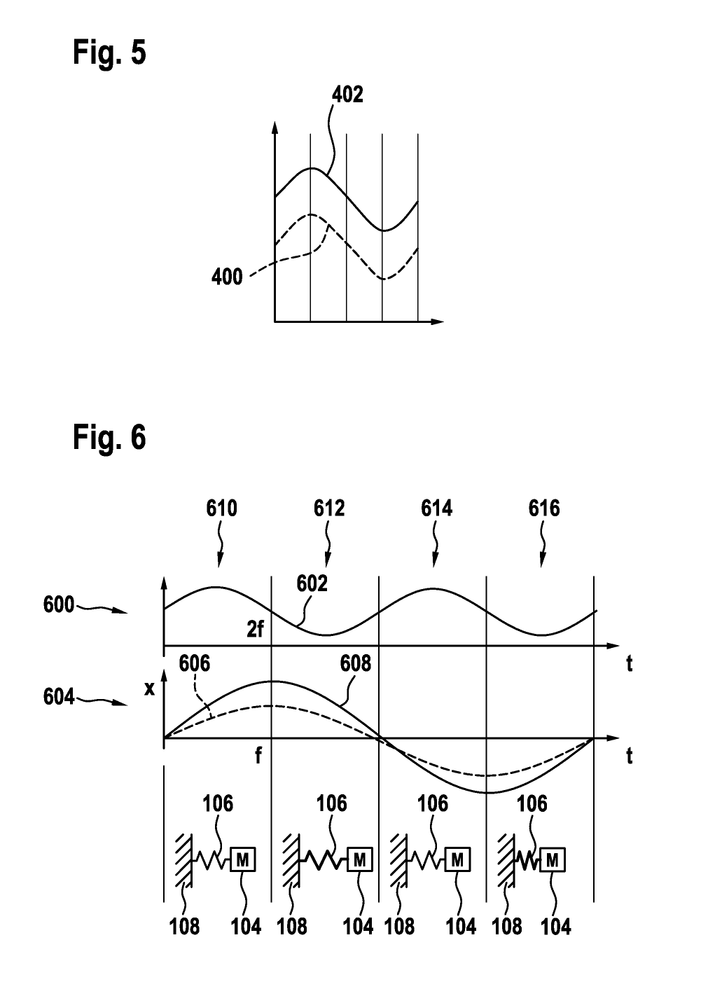

FIG. 5 shows an illustration of influencing a vibration of a mass of a rotation rate sensor by means of a DC component;

FIG. 6 shows an illustration of influencing a vibration of a mass of a rotation rate sensor by means of an amplification signal according to an exemplary embodiment of the present invention;

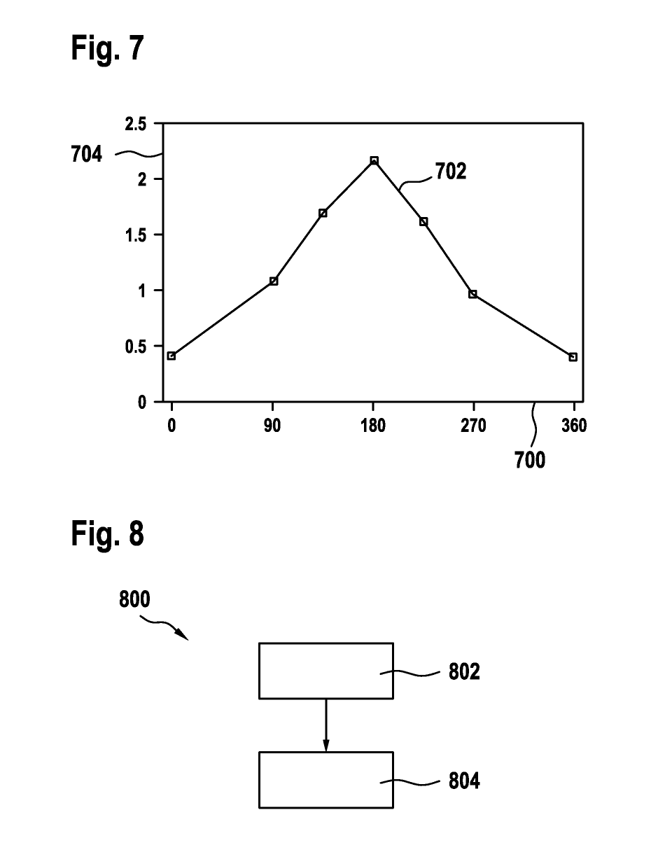

FIG. 7 shows a connection between a phase shift of an amplification signal and a vibration amplitude of a vibration according to an exemplary embodiment of the present invention;

FIG. 8 shows a flowchart of a method for setting the dynamic range of a rotation rate sensor according to an exemplary embodiment of the present invention; and

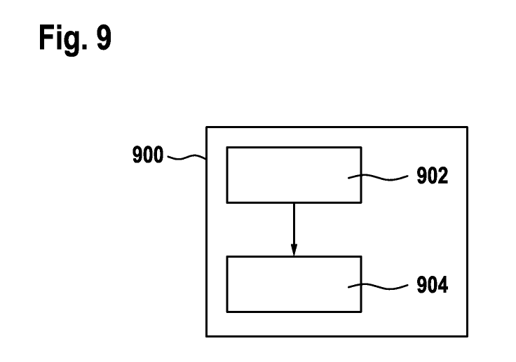

FIG. 9 shows a block diagram of a device for setting the dynamic range of a rotation rate sensor according to an exemplary embodiment of the present invention.

In the following description of beneficial exemplary embodiments of the present invention, the same or similar reference symbols are used for the similarly acting elements illustrated in the various figures, a repeated description of these elements being omitted.

FIG. 1 shows an illustration of a rotation rate sensor 100 having parallel electrodes 102 according to an exemplary embodiment of the present invention. The rotation rate sensor 100 has a mass 104 mounted such that it can vibrate. The mass 104 is illustrated symbolically. The mass 104 is mounted via four springs 106. The springs 106 each connect one corner of the mass 104 to a stationary part 108 of the rotation rate sensor 100. The springs 106 are designed to counteract a deflection of the mass 104 out of a rest position in a vibration direction of the mass 104 by using a spring force. The spring force in this case is proportional to a deflection of the mass 104. The springs 106 are real spring elements and therefore have little damping. The parallel electrodes 102 are likewise connected to the stationary part 108 and are formed as plates which are oriented parallel to a surface of the mass 104. The parallel electrodes 102 are arranged on sides of the mass 104 that are diametrically opposite in the vibration direction. In order to deflect the mass 104 out of the rest position determined by the springs 106, the mass 104 is brought to an electric potential during operation. If an oppositely directed potential is applied to the parallel electrode 102, the mass 104 is attracted by the parallel electrode 102 by electrostatic forces between the mass 104 and the parallel electrode 102. As a result of the electrostatic forces, the mass 104 is deflected out of the rest position counter to the spring force of the springs 106. In order to excite the mass 104 to vibrate in the vibration direction, the polarities of the electrodes 102 are regularly reversed. In particular, the polarity of the electrodes 102 is reversed at an excitation frequency which lies in the region of a resonant frequency of the vibration-capable system comprising mass 104 and springs 106. If the excitation frequency coincides approximately with the resonant frequency, the mass 104 can experience a very great deflection.

If the rotation rate sensor 100 is rotated with the mass 104 vibrating, the Coriolis force acts on the mass 104. The Coriolis force is oriented orthogonally with respect to the rotation and orthogonally with respect to the vibration direction. The mass 104 is therefore deflected laterally by the Coriolis force, transversely with respect to the vibration direction. The lateral deflection is therefore the greatest when the rotation takes place at right angles to the vibration direction. If the rotation takes place parallel to the vibration direction, no Coriolis force acts on the mass 104. The magnitude of the lateral deflection is proportional to a rate of rotation of the rotation and an amplitude of the vibration. The lateral deflection is determined by measuring means, not illustrated here. In the case of a high rate of rotation, a reduced vibration amplitude is sufficient to obtain a measurable lateral deflection.

In the case of a low rate of rotation, an increased vibration amplitude is needed in order to obtain a measurable lateral deflection.

To measure the rotation rate signal, use is made of the Coriolis effect. Here, the Coriolis force F_{c} acting on a Coriolis mass m_{c} which moves with the speed v as a result of a rotation rate Ω is calculated from:

F_{c}=−2·m_{c}·Ω×v

This means that the Coriolis mass m_{c} is accelerated orthogonally with respect to the speed direction and the rotation rate Ω that is applied, and a lateral movement of the Coriolis mass m_{c} resulting from the acceleration can be measured, for example capacitively. This lateral movement is also designated a detection movement. As can be seen from the above formula, a speed component v is required for this purpose. The speed component v is achieved in that the sensor mass is set into a harmonic vibration. This movement is designated a drive movement.

The speed component v can be controlled in order to keep the measurement dependent only on the measured variable Ω. The oscillation amplitude of the drive movement can be influenced by external influences, such as a temperature-induced quality change. Therefore, use can be made of an electronic circuit to control this amplitude to a desired set point. This circuit can be designated automatic amplitude control (automatic gain control, AGC). A schematic structure of a drive oscillator 104 of a rotation rate sensor 100 is illustrated in FIG. 1. The mass 104 is set oscillating by using a drive signal. This is achieved by applying two drive signals with the frequency f, shifted by 180° phases, to the drive electrodes 102.

In order to set a dynamic range of the rotation rate sensor 100, the mass 104 is excited to vibrate linearly by means of a drive signal with constant amplitude. The drive signal is applied to at least one of the parallel electrodes 102. The drive signal is provided at a constant frequency. In order to influence the amplitude of the vibration, an amplification signal at a multiple of the frequency is provided on at least one of the parallel electrodes 102.

In one exemplary embodiment, the drive signal is applied to one of the parallel electrodes 102 in order to keep or set the mass 104 vibrating. The amplification signal is applied to the other parallel electrode 102 in order to influence an amplitude of the vibration and to set the dynamic range.

In one exemplary embodiment, the drive signal and the amplification signal are provided so as to be superimposed on at least one of the parallel electrodes 102.

In one exemplary embodiment, the rotation rate sensor 100 has a means for exciting the mass. The excitation means is designed to provide a drive signal on the parallel electrodes 102 at a resonant frequency of the mass 104. Furthermore, the rotation rate sensor 100 has a means for influencing the mass. The influencing means is designed to provide the amplification signal on the parallel electrodes 102 at a multiple of the resonant frequency in order to set a dynamic range of the rotation rate sensor 100.

In other words, FIG. 1 shows a schematic structure of a spring-mass system 100 with parallel electrodes 102 for the parametric resonance technique.

In one exemplary embodiment, the rotation rate sensor 100 has a means for exciting the mass. The excitation means is designed to provide a drive signal on the electrodes 102 at a resonant frequency of the mass 104. Furthermore, the rotation rate sensor 100 has a means for influencing the mass. The influencing means is designed to provide the amplification signal on the electrodes 102 at a multiple of the resonant frequency in order to set a dynamic range of the rotation rate sensor 100.

A sensitivity setting can be achieved by the parametric 2f signal being varied in amplitude or phase and, as a result, changing the spring stiffness. Since the 2f signal does not have to be in the high-voltage range, this circuit is correspondingly much simpler to implement.

A further concept for dynamic range adaptation is represented by the parametric amplification in the detection circuit, not illustrated. The application of the parametric amplification is carried out in a manner analogous to the approach of the drive circuit presented here. The feed can be provided on additional electrodes but also on existing electrodes, for example by superimposing a DC potential on the AC signal of the parametric amplification.

Furthermore, a combination of detection and drive feed can also be selected. Here, it is advantageous that the action is amplified multiplicatively and thus, in each individual feed of the parametric amplification signal, smaller amplitudes can be selected and thus possible nonlinearity effects, which may occur at higher excitation signal amplitudes, can be reduced. This method of feeding on both paths is therefore recommended in the case of particularly high dynamic range settings.

In all the feeding methods, the setting can be carried out in defined stages or in a freely scalable manner.

The free scalability of the dynamic range adaptation offers the possibility of setting respectively optimal amplifications adjusted dynamically with the output signals. This possibility demands a characteristic curve of the amplification effect that is resolved precisely via influencing parameters in order to avoid non-linear sensitivity variations during the setting of the respective parametric amplification.

Although the stepped amplification offers a lower ability to adapt to the rate of rotation range that is respectively actually present, the requirements on the characteristic curve adjustment are reduced. If an application makes access to the rotation rate signal, said application can specify the dynamic range to be selected before the start of the application and/or also during operation of the application. This can be implemented simply, since most applications normally operate in the same dynamic range, specifically gaming applications, for example, with high rates of rotation, navigation normally with low rates of rotation. By means of a fixed selection of the parametric amplification, the linearity is always ensured within the selected dynamic range. The adjustment costs (characteristic curve determination) are therefore lower.

FIG. 2 shows an illustration of a rotation rate sensor 100 having comb electrodes 200. The rotation rate sensor 100 corresponds substantially to the rotation rate sensor in FIG. 1. Here, the rotation rate sensor has only two springs 106. The springs 106 are distributed onto the surfaces of the mass 104 which are opposite in the vibration direction and, as in FIG. 1, are oriented in the vibration direction. As opposed to FIG. 1, the electrodes are formed as comb electrodes 200 with combs oriented transversely with respect to the surface of the mass 104. In each case three prongs 202 are grouped to form an interengaging comb electrode 200. Here, the mass 104 has two electrically conductive prongs 202 per side, projecting in the vibration direction. A respective interspace is arranged between the two prongs 202. Arranged in this interspace is a respective third prong 202 connected to the fixed part 108. All the prongs 202 are oriented in the vibration direction. Here, the mass 104 cannot necessarily be electrified.

Comb electrodes 200 are used for the actuating mechanism here.

In one exemplary embodiment, the prongs 202 connected to the mass 104 are set to the electric potential of the mass 104 in FIG. 1. As a result, an attractive force can be exerted on the mass 104 via the potential applied to the stationary prongs 202.

In each case two of the prongs 202 are arranged on opposite sides of the mass 104.

A schematic structure of a drive oscillator 100 having comb electrodes 200 is illustrated in FIG. 2.

FIG. 3 shows an illustration of a rotation rate sensor 100 having comb electrodes 200 and parallel electrodes 102 according to an exemplary embodiment of the present invention. As in FIG. 2, the rotation rate sensor 100 has a mass 104 mounted such that it can vibrate and having two oppositely arranged springs 106. The parallel electrodes 102 correspond to the parallel electrodes in FIG. 1. The comb electrodes 200 correspond to the comb electrodes in FIG. 2. In each case one of the parallel electrodes 102 and one of the comb electrodes 200 are arranged on one side of the mass 104.

In other words, FIG. 3 shows a schematic structure of a drive oscillator 100 having additional parallel electrodes 102 for the parametric amplification.

In one exemplary embodiment, the drive signal is provided on the comb electrodes 200. The amplification signal is provided on the parallel electrodes 102.

As the range of uses grows continuously, the requirements on current rotation rate sensors 100 increase. In addition to typical tasks in the automotive sector in vehicle stabilization (e.g. ESP), new tasks in the area of navigation and navigation support arise with considerably lower rotation rates and therefore a considerably higher required sensitivity. The range of uses goes still further in consumer electronics. Here too, the use of rotation rate sensors is increasing in significance, for example for the detection of low rates of rotation in navigation, but also added to this are gaming applications in which very high rates of rotation have to be detected. This places enormous requirements on the dynamic range and the signal-to-noise ratio of the evaluation unit. In particular, this applies to the capacitance-to-voltage converter (CU converter) typically used in the case of capacity detection and to the analogue-to-digital conversion.

In order to satisfy these requirements, the sensitivity of the rotation rate detection can be adapted variably to a predefined measurement range. For this purpose, the drive amplitude and thus the speed component v in the Coriolis force equation can be varied. As a result, the rotation rate signal Q to be measured can be scaled differently. For example, in the measurement range of small rates of rotation Q, excitation is carried out with a high drive amplitude, and thus the resultant Coriolis force and therefore the detection signal are increased.

By means of the method presented here, a shift of the drive control from the high-voltage range (complex) into the low-voltage range is made possible.

FIG. 3 illustrates a concept in which the drive oscillation is amplified parametrically. A drive signal at the frequency f is applied to the drive electrode 200, and to the second drive electrode 200 with a 180° phase shift, and thus the sensor mass 104 is set vibrating. By using the additional parallel electrodes 102, a 2f signal with appropriate phase is applied. This effects a softening and a hardening of the spring stiffness, in each case at the correct time. As a result, the vibration amplitude can be maximized.

Amplitude control can be achieved by the parametric 2f signal and, as a result, the spring stiffness, being varied. An increase in the amplitude of the 2f signal leads, for example, to an increase in the amplitude of the drive oscillation. Since the 2f signal does not have to be in the high-voltage range, this circuit is accordingly much simpler to implement.

Setting the sensitivity can then be achieved by the parametric 2f signal and, as a result, the spring stiffness being varied. An increase in the amplitude of the 2f signal leads, for example, to a greater deflection of the detection mass 104.

A concept relating to dynamic range adaptation can be implemented by using parametric amplification in the drive circuit. FIG. 3 shows a concept in which the drive oscillation is amplified parametrically. By means of the drive electrodes 200, the sensor mass 104 is set vibrating with a 180° phase-shifted drive signal at the frequency f. Then, instead of varying the drive voltage on the drive electrodes 200, a 2f signal with appropriate phase is applied by means of the additional parallel electrodes 102. This effects a softening and a hardening of the spring stiffness, in each case at the correct time. As a result, the vibration amplitude can be maximized.

FIG. 4 shows an illustration of influencing a vibration of a mass of a rotation rate sensor by means of an increase in amplitude. A graph 400 of a drive signal of the mass in the course of one oscillation is illustrated. One complete oscillation of the drive signal 400 is illustrated. A phase of the oscillation from 0 to 2n is plotted on the abscissa. The amplitude is plotted on the ordinate. Here, the abscissa is not arranged on a zero point of the oscillation. The drive signal is sinusoidal. Beside the drive signal 400, a graph 402 of a drive signal with increased amplitude is illustrated. This drive signal 402 has the same frequency as the drive signal 400. In order to increase the amplitude of the oscillation and to increase a sensitivity of the rotation rate sensor, the amplitude of the drive signal 402 has been increased in order to excite the mass with a greater force.

FIG. 5 shows an illustration of influencing a vibration of a mass of a rotation rate sensor by means of a DC component. The illustration of FIG. 5 is similar to the illustration in FIG. 4. As opposed to FIG. 4, the drive signal 402 is increased by a DC component as compared with the drive signal 400.

FIGS. 4 and 5 each show a scenario in which the vibration amplitude drops as a result of external influences. As a countermeasure, either the AC amplitude of the drive signal 402 as in FIG. 4 or the DC potential as in FIG. 5 can be increased (continuous line). A signal variation of the drive voltage in the case of an AC control and a DC control is shown. For this purpose, the drive voltages, generally applied in the high-voltage range, are controlled. This requires a complex analogue circuit which is designed to control very high voltages with changes in the millivolt range.

In other words, in FIGS. 4 and 5 two typical implementations relating to the control of the drive amplitude are illustrated by using the schematic variation in the drive signal. The dashed line 400 represents the configuration in which high rates of rotation can be detected (lower drive amplitude). An increase in the AC signal as in FIG. 4 or of the DC potential as in FIG. 5, identified by the continuous lines 402, leads to a greater deflection of the drive oscillator and thus to a higher speed component v in the Coriolis equation. This permits the detection of lower rates of rotation, which, for example, is needed for inertial navigation.

By means of the approach presented here, the need for a drive circuit that can be set in the high-voltage range is dispensed with. The precise control of low-voltage stages can be implemented with a low area requirement and a low power consumption.

FIG. 6 shows a first graph 600 with an amplitude curve 602, representing an amplification signal, according to an exemplary embodiment of the present invention. Arranged in a manner correlated chronologically therewith is a second graph 604, in which a first deflection curve 606 and a second deflection curve 608 of a mass 104 of a rotation rate sensor are plotted. Once more correlated chronologically therewith, the mass 104 is depicted in four phases 610, 612, 614, 616 of an individual basic vibration. The mass 104 is represented as a system capable of vibration and having a spring 106, which connects the mass 104 to a fixed part 108 of the rotation rate sensor. In the first graph 600, the time is plotted on the abscissa. Plotted on the ordinate is an amplitude of an electric voltage of the amplification signal 602. In the second graph 604, the time is likewise plotted on the abscissa. Here, a deflection x of the mass 104 out of a rest position is plotted on the ordinate. The first deflection curve 606 represents the deflection x of the mass 104 without being influenced by the amplification signal 602. The second deflection curve 608 represents the deflection x of the mass 104 with an influence exerted by the amplification signal 602. Without the amplification signal 602, the mass 104 vibrates with a sinusoidal basic vibration 606 about a rest position on account of the drive signal, not illustrated here. The basic vibration 606 is illustrated dashed here. The basic vibration 606 has a frequency f. The amplification signal 602 has a frequency 2f that is twice as high. The amplification signal 602 is represented as a fluctuating DC voltage signal. In all the phases 610, 612, 614, 616 of the basic vibration 606, the voltage of the amplification signal 602 therefore has the same sign. By means of the amplification signal 602, a force fluctuating synchronously with the amplification signal 602 is therefore exerted on the mass 104. The force resulting from the amplification signal 602 supplements or reduces a restoring spring force of the spring 106, depending on the phase 610, 612, 614, 616. The second deflection curve 608 describes the deflection x during one complete vibration.

At the start of the first phase 610, the mass is located in the rest position but has its maximum speed of movement. In the first phase 610, the restoring force of the spring 106 is weakened. As a result, the spring 106 acts more softly than its basic spring constant. The momentum of the mass 104 is able to stretch the spring 106 more strongly. The mass 104 therefore vibrates further out of the rest position than without the amplification signal 602. The deflection x at the end of the first phase 610 has reached a first maximum of the vibration. At the end of the first phase 610, the speed of the mass 104 is zero.

At the start of the second phase 612, the direction of movement of the mass 104 reverses. In the second phase 612, the restoring force of the spring 106 is amplified. As a result, the spring 106 acts harder than the spring constant. Therefore, an increased acceleration in the direction of the rest position acts on the mass 104. Therefore, at the end of the second phase 612, the mass 104 reaches its maximum speed and goes through the rest position synchronously with the basic vibration 606. The speed is greater than the maximum speed of the basic vibration 606.

At the start of the third phase 614, the mass 104 passes through the rest position at its maximum speed. In the third phase 614, the restoring force of the spring is weakened again. As a result, the spring 106 once more acts more softly than the spring constant.

The momentum of the mass 104 is able to stretch the spring 106 more strongly than without the amplification signal 602. The mass 104 therefore vibrates further out of the rest position. The deflection x at the end of the third phase 614 has reached a second maximum of the vibration. At the end of the first phase 610, the speed of the mass 104 is again zero.

At the start of the fourth phase 616, the direction of movement of the mass 104 again reverses. In the fourth phase 616, the restoring force of the spring 106 is amplified. As a result, the spring 106 again acts harder than the spring constant. Therefore, an increased acceleration in the direction of the rest position again acts on the mass 104. Therefore, at the end of the fourth phase 616, the mass 104 again reaches its maximum speed and once more goes through the rest position synchronously with the basic vibration 606. The speed at the end of the fourth phase 616 is higher than the maximum speed of the basic vibration 606.

If the amplification signal 602 is provided with a changed amplitude, then the resultant deflection x of the mass also changes in a corresponding way.

The complexity of a drive circuit in the high-voltage range can be reduced by using the method of parametric amplification presented here. The parametric amplification can be carried out with the aid of small

AC voltages 602 in the low-voltage range of the sensor element. This is simpler to implement in terms of circuitry. The technique of parametric amplification can be used to increase the lateral detection movement and thus to increase the sensitivity.

By means of the method presented here, the dynamic range of the rotation rate detection is set via the parametric resonance technique. This has the advantage that the drive circuit, which typically operates in the high-voltage range (10 V to 20 V), no longer has to be variable and therefore can be enormously simplified. This simplification of the drive circuit permits a saving in space on the ASIC (Application Specific Integrated Circuit), can permit an ASIC process with lower maximum voltages and reduces the power demand of the high-voltage stages. With these advantages, a distinct reduction in costs of an ASIC with variable sensitivity range is possible.

The parametric amplification can be carried out with the aid of small AC voltages 602, typically up to 4 V, on the sensor element. This is considerably simpler to implement in terms of circuitry than a variation in the voltage of the high-voltage stages. By using this method, different sensitivity modes can be set.

The parametric amplification describes a method in which the spring stiffness k_{eff} of a spring-mass system that can vibrate is varied periodically. By means of in-phase variation of the spring stiffness k_{eff}, the deflection of a vibrating mass m is increased by the spring stiffness k_{eff} being reduced in the deflection phase and increased in the restoration phase.

A variation in the spring stiffness can be effected by the “electrostatic spring softening effect”. This occurs in the case of nonlinear capacity changes via the electrode spacing, such as for example in plate capacitors (also called parallel electrodes below). Here, a mechanical spring stiffness k_{mech} is expanded by an electric spring stiffness kₑₗ to form an effective spring stiffness k_{eff}.

$${k}_{eff} = {k}_{mech} + {k}_{el}$$

$${k}_{el} = - \frac{A \cdot ɛ}{{( {x}_{o} + x )}^{3}} \cdot {U}_{P}^{2}$$

Here, U₂ describes the parametric excitation voltage which is applied to the parallel electrodes (102 in FIG. 1 and FIG. 3).

Uₚ=U_{DC,P}+Û_{P}·sin(2π·2f·t+Φ)

Assuming a periodic deflection x of a spring-mass system at the frequency f by means of a force, for example the Coriolis force, this force can be amplified by the parametric amplification by means of the in-phase application of a 2f signal 602 with phase Φ). FIG. 6 shows the time variation in the signals 602 of the parametric amplification. In the region 610, the mass m is deflected in a positive direction (dashed line 606). A softening of the spring stiffness at this time leads to an additional deflection, as shown by the continuous line 608 of the deflection x. This softening is achieved by in-phase application of the positive half wave, that is to say by an increase in the voltage signal U on the electrodes. In the region 612, the mass 104 is retracted into the rest position by the spring stiffness (dashed line 606). By means of in-phase application of the negative half wave, that is to say a reduction in the voltage signal U on the electrodes, an additional hardening of the spring stiffness is achieved. As a result, the mass 104 previously deflected further by the parametric amplification is pulled back more quickly into the rest position (continuous line 608). Region 614 is analogous to region 610, and region 616 is analogous to region 612, in each case the sign of the deflection x being inverted.

As a result of the application of the parametric amplification, the complicated drive circuit which operates in the high-voltage range can be simplified enormously since, by using the method presented here, a constant harmonic drive signal in the high-voltage range can be used. This drive signal in the high-voltage range (typically up to 20 V) must be varied neither in the AC nor in the DC component. The amplitude control is instead carried out with the aid of the parametric resonance technique. Here, a 2f signal 602 is applied to an additional parallel electrode. This 2f signal is controlled, but since this signal 602 can be in the low voltage range (typically about 3 V), the outlay on circuitry is reduced considerably.

In one exemplary embodiment, FIG. 6 shows the variation 608 of the normalized deflection x of the drive oscillation over one period of the drive oscillation. An influence of the parametric amplification signal 602 on the deflection x can clearly be seen.

Since this type of amplitude control requires no control of the high-voltage stages, new possibilities of reducing area and power loss within the ASIC result here. The comb electrodes 200, which in FIG. 3 are used for the drive movement, can be omitted here, as illustrated in FIG. 1. The drive signal and the parametric amplification signal U_{P} (2f signal) are applied in a superimposed manner to the parallel electrodes 102. In other words, FIG. 1 shows a schematic structure of the drive oscillator only with parallel electrodes 102. The drive signal U_{A} and the parametric amplification signal U are applied to the parallel electrodes. In the following equations, the two DC potentials are combined.

U₁₀₂ᵣ=U_{DC}+Û_{A}·sin(2π·f·t)+Û_{P}·sin(2π·2f·t+Φ)

U₁₀₂ₗ=U_{DC}−Û_{A}·sin(2π·f·t)+Û_{P}·sin(2π·2f·t+Φ)

U_{A}=U_{DC,A}+Û_{A}·sin(2π·2f·t)

U_{DC}=U_{DC,A}+U_{DC,P}

In other words, FIG. 6 shows the variation over time of the parametric amplification signal 602. The illustration shows a deflection x of the oscillation amplitude of the drive oscillator as a function of the phase 610, 612, 604, 616 of the parametric excitation signal 602 (2f signal). The deflection x is normalized to the basic deflection without the parametric resonance amplification technique.

FIG. 7 shows a relationship between a phase shift 700 of an amplification signal and a vibration amplitude of a vibration according to an exemplary embodiment of the present invention. The relationship is plotted as a graph 702 in a diagram. The phase shift 700 between the amplification signal and a basic vibration is plotted in degrees on the abscissa of the diagram. An amplification factor 704 of the resultant vibration amplitude between zero and 2.5 is plotted on the ordinate, wherein an amplification factor 704 of one represents both no amplification and no attenuation of the vibration amplitude. With a phase shift 700 of zero degrees, an amplification factor 704 of 0.4 results. This means that the vibration amplitude of the basic vibration is reduced by 60 percent. With a phase shift 700 of 90 degrees, an amplification factor 704 of approximately 1.1 results. This means that the vibration amplitude of the basic vibration remains approximately the same. With a phase shift 700 of 135 degrees, an amplification factor 704 of 1.7 results. This means that the vibration amplitude of the basic vibration is increased by 70 percent. With a phase shift 700 of 180 degrees, an amplification factor 704 of 2.2 results. This means that the vibration amplitude of the basic vibration is increased by 120 percent. With a phase shift 700 of 225 degrees, an amplification factor 704 of approximately 1.7 again results. This means that the vibration amplitude of the basic vibration is increased by approximately 70 percent. With a phase shift 700 of 270 degrees, an amplification factor 704 of 1 results. This means that the vibration amplitude of the basic vibration remains the same. With a phase shift 700 of zero degrees or 360 degrees, an amplification factor 704 of 0.4 again results. This means that the vibration amplitude of the basic vibration is reduced by 60 percent.

Instead of a variation of the amplitude of the 2f signal, the drive oscillation can be controlled by a shift 700 in the phase. This is possible since the parametric resonance amplification, at which the spring stiffness is softened or hardened, depends on the times and thus on the phase. This is still more advantageous, since the amplitude of the 2f signal can likewise be uncontrolled. As a result, the drive signal and the parametric signal on the electrodes are constant from the point of view of the amplitude. The phase shift 700 can be implemented simply by means of adjustable delay elements.

FIG. 8 shows a flowchart of a method 800 for setting the dynamic range of a rotation rate sensor according to an exemplary embodiment of the present invention. The method 800 has an excitation step 802 and an influencing step 804. In the excitation step 802, a mass of the rotation rate sensor that is mounted such that it can vibrate is excited to vibrate linearly by using a drive signal. The drive signal is provided at a resonant frequency of the mass. In the influencing step 804, the vibration is influenced by using an amplification signal. The amplification signal is provided in particular at a multiple of the resonant frequency in order to set the dynamic range.

In one exemplary embodiment, the amplification signal is provided with a phase offset in relation to the drive signal.

In one exemplary embodiment, in the influencing step a first dynamic stage of the dynamic range is set by using a first phase offset. Following chronologically therefrom, a second dynamic stage of the dynamic range is set by using a second phase offset. The first phase offset is different from the second phase offset.

In one exemplary embodiment, in the influencing step at least one further dynamic stage of the dynamic range is set by using a further phase offset.

In one exemplary embodiment, the amplification signal is provided with a variable amplitude in order to influence the dynamic range.

In one exemplary embodiment, the amplification signal is provided at twice the resonant frequency.

In one exemplary embodiment, the drive signal is provided in the high-voltage range. In one exemplary embodiment, the amplification signal is provided in the low-voltage range.

In one exemplary embodiment, the drive signal is provided as an AC signal oscillating sinusoidally about a voltage value.

In one exemplary embodiment, the amplification signal is provided as a DC signal fluctuating sinusoidally about a voltage value.

In one exemplary embodiment, the drive signal and the amplification signal are provided on a common electrode. In the case of opposite electrodes, the drive signal and the amplification signal are provided on the electrodes with a 180° phase offset.

In one exemplary embodiment, the drive signal is provided on at least one drive electrode. In the case of opposite drive electrodes, the drive signal is provided on the drive electrodes with a 180° phase offset. In one exemplary embodiment, the amplification signal is provided on at least one parallel electrode.

In the case of opposite parallel electrodes, the amplification signal is provided on the parallel electrodes with a 180° phase offset.

In other words, FIG. 8 shows a flowchart of a method 800 for setting the dynamic range of a rotation rate sensor by means of parametric amplification. Here, in order to control the drive circuit of a rotation rate sensor, a parametric amplification signal is fed in.

FIG. 9 shows a block diagram of a device 900 for setting the dynamic range of a rotation rate sensor according to an exemplary embodiment of the present invention. The device 900 has an excitation means 902 and an influencing means 904. The excitation means 902 is designed to excite a mass of the rotation rate sensor mounted such that it can vibrate by using a drive signal. The excitation means 902 is designed to provide the drive signal at a resonant frequency of the mass. The influencing means 904 is designed to influence the mass by using an amplification signal. The influencing means 904 is designed to provide the amplification signal in particular at a multiple of the resonant frequency in order to set the dynamic range.

The exemplary embodiments described and shown in the figures have been chosen only by way of example. Different exemplary embodiments can be combined with one another completely or with reference to individual features. In addition, one exemplary embodiment can be supplemented by features of a further exemplary embodiment.

Furthermore, method steps according to the invention can be executed repeatedly and in a sequence different from that described.

If an exemplary embodiment comprises an “and/or” link between a first feature and a second feature, this is to be read such that the exemplary embodiment according to one embodiment has both the first feature and the second feature and, according to a further embodiment, has only the first feature or only the second feature.

1. A method for setting the dynamic range of a rotation rate sensor, the method comprising:
exciting a mass of the rotation rate sensor mounted such that the mass is configured to vibrate linearly using a drive signal, the drive signal being provided at a resonant frequency of the mass; and
influencing the vibration using an amplification signal, the amplification signal being provided at a multiple of the resonant frequency in order to set a dynamic range.

2. The method as claimed in claim 1, wherein the amplification signal is provided with a phase offset in relation to the drive signal.

3. The method as claimed in claim 2, wherein the influencing of the vibration includes a first dynamic stage, wherein the dynamic range is set using a first phase offset and,
following chronologically thereon, at least one further dynamic stage, wherein the dynamic range is set using at least one further phase and the first phase offset differs from the further phase offset.

4. The method as claimed in claim 1, wherein the amplification signal is provided with a variable amplitude in order to influence the dynamic range.

5. The method as claimed in claim 1, wherein the amplification signal is provided at twice the resonant frequency.

6. The method as claimed in claim 1, wherein the drive signal is provided in the high-voltage range, and the amplification signal is provided in the low-voltage range.

7. The method as claimed in claim 1, wherein the drive signal is provided as an AC signal oscillating sinusoidally about a voltage value.

8. The method as claimed in claim 1, wherein the amplification signal is provided as a DC signal fluctuating sinusoidally about a voltage value.

9. The method as claimed in claim 1, wherein the drive signal and the amplification signal are provided on a common electrode.

10. The method as claimed in claim 1, wherein the drive signal is provided on at least one drive electrode and the amplification signal is provided on at least one parallel electrode.

11. A device for setting the dynamic range of a rotation rate sensor, comprising:
a first module configured to excite a mass of the rotation rate sensor mounted such that the mass is configured to vibrate by using a drive signal, wherein the first module is configured to provide the drive signal at a resonant frequency of the mass; and
a second module configured to influence the mass by using an amplification signal, wherein the second module is configured to provide the amplification signal at a multiple of the resonant frequency in order to set the dynamic range.

12. A rotation rate sensor, comprising:
at least one mass mounted such that the mass is configured to vibrate, wherein the mass can be excited by electrostatic forces;
at least one electrode configured to excite the mass;
a first module configured to excite the mass by using a drive signal, wherein first module is configured to provide the drive signal on the electrode at a resonant frequency of the mass; and
a second module configured to influence the mass by using an amplification signal, wherein the second module is configured to provide the amplification signal on the electrode at a multiple of the resonant frequency in order to set a dynamic range of the rotation rate sensor.

13. A computer program product with program code for carrying out the method as claimed in one of claim 1 when the program product is executed on a device.
